(19) United States
(12) Patent Application Publication
(10) Pub. No.: US 2017/0265451 A1
(43) Pub. Date: Sep. 21, 2017

(54) Self Resetting Pest Trap

(71) Applicant: Daryl PINDER, Bendigo (AU)

(72) Inventor: Daryl PINDER, Bendigo (AU)

(21) Appl. No.: 15/478,665

(22) Filed: Apr. 4, 2017

Related U.S. Application Data
(63) Continuation of application No. 14/402,129, filed on Nov. 19, 2014, now abandoned.

(30) Foreign Application Priority Data
May 21, 2012 (AU) 2012902077

(51) Int. Cl. A01M 23/14; A01M 19/00; A01M 23/06; A01M 23/04

(52) U.S. Cl. CPC A01M 23/14; A01M 23/04; A01M 23/06; A01M 2200/00; A01M 19/00

(57) ABSTRACT

A trap for assisting in controlling pest populations, in particular rodent, and especially rats and/or mice, including: a lower housing, and a false floor including a trapdoor, and a ramp, wherein the lower housing has a lower end that sits on the ground and an upper end. The false floor is attached to the upper end of the lower housing. The trap door is triggered to suddenly collapse when the rodent places a sufficient amount of its body weight onto the trapdoor. The ramp leads up from ground level to the false floor so that when in use, a suitable liquid or gas is contained within the lower housing, and a suitable bait is placed on the false floor to attract a rodent and maneuver it onto the trapdoor. The rodent is able to easily climb up to the false floor by way of the ramp, and when the rodent moves towards the bait, and places sufficient weight upon the trapdoor, the trapdoor suddenly collapse under it, thereby causing it to drop into the lower housing, wherein the rodent drown in the liquid or suffocates in the gas.

### CROSS-REFERENCE TO RELATED APPLICATIONS

This application is a continuation of U.S. patent application Ser. No. 14/402,129 filed on Nov. 19, 2014 which is a 371 US National Stage of International Application No. PCT/AU2013/000524, filed May 21, 2013 and published in English as WO 2013173866 A1 on Nov. 28, 2013, which claims priority to Australian Patent Applicant No. 2012902077, filed May 21, 2013. The entire disclosures of each of the above applications are incorporated herein by reference.

### FIELD

This invention relates to traps for controlling the population of pests such as rodents, and in particular rats and mice. The invention relates to self-resetting traps that are capable of multiple repetitive actions to trap and kill multiple rodents.

### BACKGROUND

Pest control is a multi-billion dollar industry. Traps are commonly used to control pest populations, particularly in respect of rodent populations. The most common types of rodent populations requiring control are rats and mice.

There are many types of traps in use today for rats and mice, with the most common type being the rat or mouse trap. These types of traps provide a snapping action that causes a bar or hammer type arrangement to apply a sudden blunt force trauma to the animal. Typically these are single use traps, and once sprung, they need to be manually reset. Efforts have been made to produce a single trap that has multiple mechanisms within the single trap. Each mechanism can be sprung individually, so in theory, each mechanism can each catch a single rat or mouse. Periodically, these type of traps need to be reset after a multiple of the mechanisms have been sprung.

There are a number of problems associated with these types of common trap. The first major problem is that each mechanism that has sprung, needs to be manually reset. There are many situations where the control of multiple pests are desirable. Some typical examples of these situations include farm buildings such as barns, factories, storage facilities, especially ones storing food such as grain. Holiday homes which are typically only dwelt in infrequently. In many of these situations, it is not possible or convenient to continuously visit the trap and reset it for additional trapping use.

The second major problem is that it is common for the blunt force trauma applied to the body of the rat or mouse by these types of traps, typically in the head or neck region of the animal's body, to cause the skin to break, and therefore cause a significant amount of blood to be spilled in the vicinity of the trap. This is unsightly, and may attract further pests such as flies and ants, and is potentially a biohazard.

The third major problem is that it is common for an animal to not be killed outright by the application of the blunt force trauma to its body, and to be pinned by the trap in considerable pain and suffering until it loses consciousness and eventually dies.

The fourth major problem is that once the animal has died, decomposition commences, with the associated stench and biohazard that decomposition entails. Again, this has the problem of attracting additional pests to the scene, such as ants, maggots and flies.

Finally, in the case of a trap with multiple mechanisms, the presence of a distressed rat or mouse that is pinned by the trap, and not yet unconscious or dead can deter additional rats or mice from approaching the trap, thereby reducing its effectiveness in catching multiple animals with a single trap.

It is an object of the present invention to ameliorate at least some of these major problems with the prior art by providing a more humane form of trapping and efficiently and effectively killing multiple pests using a single trap that is also capable of automatically resetting so that it is really for additional trapping operations. In addition, it is an object to safely store the carcasses of the multiple rodents killed by the trap in a safe and convenient storage area within the trap.

### SUMMARY

Accordingly, the present invention is a trap for assisting in controlling pest populations, in particular rodents, and especially rats and/or mice, including:
a lower housing, and
a false floor including a trapdoor, and
a ramp,
wherein the lower housing has a lower end that sits on the ground and an upper end. The false floor is attached to the upper end of the lower housing. The trapdoor is triggered to suddenly collapse when the rodent places a sufficient amount of its body weight onto the trapdoor. The ramp leads up from ground level to the false floor so that when in use, a suitable liquid or gas is contained within the lower housing, and a suitable bait is placed on the false floor to attract a rodent and maneuver it onto the trapdoor. The rodent is able to easily climb up to the false floor by way of the ramp, and when the rodent moves towards the bait, and places sufficient weight upon the trapdoor, the trapdoor suddenly collapses under it, thereby causing it to drop into the lower housing, wherein the rodent drowns in the liquid, or suffocates in the gas.

Preferably the false floor is releasably attached to the lower housing.

Preferably the lower housing is sufficiently dimensioned so that it contains enough liquid or gas to completely immerse the rodent, and thereby drown or suffocate it, and store the carcass of multiple rodents within the liquid or gas.

Preferably when the lower housing contains a liquid, the liquid has a specific gravity less than 1.0 in order to reduce any buoyancy effect from the liquid onto the body of the rodent, and preferably the liquid is also sufficiently viscous to ensure the rodent must exert increased effort to hold its head above the level of the liquid. These liquid properties combine to ensure that the rodent quickly tires and can no longer hold its head above the level of the liquid and drowns, and when unconscious, it ensures that the rodent falls to the bottom of the liquid.

Alternatively, when the lower housing contains a gas, the gas is any suitable gas which is heavier than air, and that can be contained within the lower housing.

Preferably a reservoir of gas, a gas sensor probe, and gas replenishment supply control means are provided. The sensor probe is located at a suitable position on the lower housing to sense the level of the gas within the lower housing, and the probe is able to send its data back to the gas replenishment supply control means so that a set level of gas within the lower housing is maintained. Any rodent falling into the lower housing is therefore immersed in, and suffocated by, the gas.

Preferably the gas is C02.

Preferably the surface of the liquid is completely covered with a layer of small floating items such as expanded polymer foam beads. These items help to cause the rodent to become disorientated when it is submerged and swimming in the liquid.

Preferably the liquid is an oil, such as cooking oil.

Preferably an upper housing is attached to the top end, thereby providing an enclosed and concealed space above the false floor, and the upper housing includes an opening of sufficient size to permit a rodent to pass through into the concealed and-enclosed space.

In an alternative embodiment, a container is removably placed within the lower housing, and the liquid used to drown, or the gas used to suffocate, each rodent is contained wholly within the container instead of the lower housing itself.

Preferably the lower housing, or the container, includes a mesh basket that sits within the lower housing, or the container. The outer surfaces of the basket are proximate to the interior walls of the lower housing, or the container, so that when the trap needs to be emptied of rodent carcasses, the user can simply lift the basket out of the lower housing or the container, thereby allowing the liquid or gas, and any small floating items to drain out of the basket through the mesh and back into either the lower housing, or the container, leaving the carcasses in the basket ready for disposal.

Preferably, the trapdoor is retained in the closed position via quick release retention means, and adjustment means are included so that the amount of weight that the trapdoor can bear before the retention means suddenly release is adjustable.

Preferably, the trapdoor is a flat panel that sits flush with the false floor, and is arranged to pivot about a pivot line, so as to define a first portion of the flat panel that the rodent is supported by, that rotates about the pivot line in a downward direction when the trapdoor is released, and a second portion on the opposite side of the pivot line that moves correspondingly in an upward direction. The first portion is located the furthest away from the opening in the upper housing.

Preferably the flat panel is arranged so that the first portion extends out substantially further from the pivot line than the second portion.

Preferably the flat panel is biased so that it resets itself once the rodent has fallen through and into the liquid or gas.

Preferably the retention means is located on the second portion of the flat panel.

Preferably the retention means is a magnet, and the adjustment means permit the user to position of the magnet at a location on the second portion that is either closer to, or further away from the pivot line.

Preferably the entire area of the false floor comprises the flat panel.

### DRAWINGS

FIG. 1 is a partially exploded view of the present invention, showing the trapdoor in its activated position.

### DETAILED DESCRIPTION

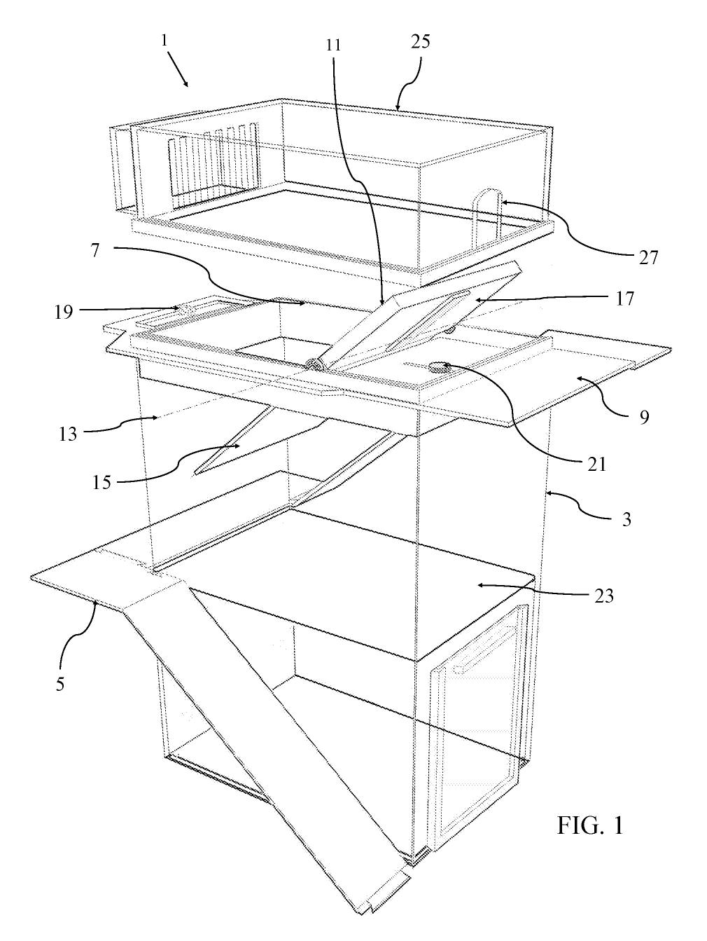

In FIG. 1 we see a trap 1 in accordance with the present invention. The trap comprises a lower housing 3, and a ramp 5 that is shown in this embodiment of the invention as spiraling around the lower housing 3. At the top end of the lower housing 3 is a false floor 7. In this example, the false floor 7 comprises a landing 9 that is attached to the ramp 5. The ramp allows the rodent to easily climb up the exterior of the trap 1 and arrive at the landing 9. In addition to the landing 9, the false floor 7 also has a trapdoor in the form of a flat panel 11. The flat panel 11 is configured to pivot about a pivot line 13. When in its set and ready to use state, the flat panel sits flush with the false floor 7 The pivoting mechanism is any suitable low friction mechanism. In this embodiment, the flat panel is shown in its activated state.

The flat panel 11 has a first portion 15 and a second portion 17. Preferably the first portion 15 extends further out from the pivot line 13 that the second portion 17 does. Rodents can be attracted to and maneuvered onto the flat panel by the placement of a suitable bait in the bait holder 19. Adjustable retention means 21 retain the second portion 17 of the flat panel in the set and ready to use position. The retention means 21 can be adjusted by manually moving the position of the retention means to a position closer, or further away from, the pivot line 13. This has the effect of either increasing or decreasing the amount of weight that the first portion 15 of the flat panel 11 can bear before the retention means 21 suddenly releases.

In this example, the lower housing 3 contains a quantity of liquid 23.

In use, optionally a suitable bait is placed in the bait holder 19. This has the effect of attracting a rodent. The rodent approaches the trap 1 from floor level and proceeds up to the level of the false floor 7 via the ramp 5. Once the rodent reaches the false floor level, it moves towards the bait in the bait holder 19 by walking across the flat panel 11 which sits flush with the level of the false floor. Once the rodent sets foot upon the first portion 15 of the flat panel 11, it starts to exert a breaking force upon the retention means 21. As the rodent moves further and further onto the first portion 15 as it approaches the bait, due to the lever action caused by the pivot line 13, the force continues to increase. Once a sufficient amount of break force is applied to the retention means 21, they suddenly release, and the first portion 15 suddenly pivots about the pivot line 13 in a downward direction as shown in FIG. 1. This causes the rodent to fall into the liquid in the lower housing 3.

After the weight of the rodent falls off the first portion 15, there is a bias in the flat panel 11 to cause the flat panel to swing back into its set and ready to use state, and to re-engage the retention means 21 ready for subsequent use.

Preferably the liquid 23 has a relative density less than 1.00 so that when the rodent lands in the liquid 23, there is no buoyancy effect experienced by the body of the rodent by the liquid 23. Preferably the liquid 23 has a higher viscosity than water so that the combined effect of the lack of buoyancy and high viscosity means that the rodent needs to exert a lot of energy just to keep its nose above the liquid level. This causes the rodent to quickly drown, and the lack of buoyancy causes the carcass to fall to the bottom of the lower housing 3. An ideal liquid to be used is a light cooking oil.

Optionally a sufficient amount of small floating items (not shown) such as expanded polymer beads are placed upon the surface of the liquid so that the entire surface of the liquid are adequately covered.

The floating items do not obstruct the rodent as it falls into the liquid, however they have the effect of completely disorientating the animal as it tries to find the liquid surface. If the rodent swims up to the surface, the nose of the animal touched the floating items and it then thinks that that is no the liquid surface, and so the animal will swim away from the surface. This has the effect of causing the rodent to drown far more quickly than it otherwise would without the floating items present. This results in a far quicker and more humane kill.

In another form of the invention, a basket (not shown) is placed within the lower housing so that periodically the trap can be cleared of accumulated rodent carcasses. The user simply removes the false floor 7 to gain access to the basket in the lower housing 3, and the user can then lift the basket out of the liquid. The mesh of the basket is sufficiently open to permit the liquid 23 and any small floating items to drain out of the basket and back into the lower housing 3, thereby leaving only the accumulated rodent carcasses, ready for disposal.

Optionally, an upper housing 25 (shown in an exploded view) is attachable to the trap 1 to provide a dark and concealed space above the false floor 7. The upper housing 25 includes an access hole 27 so that the rodent can gain access to the dark and concealed space when approached from the ramp 5.

In another embodiment of the present invention, a separate container is placed within the lower housing 3. The container is located beneath the flat panel so that any rodent falling through it is dumped into the container, and it is the container, and not the lower housing 3, that contains the liquid 23. This has the advantage of allowing a user to quickly exchange a container full of carcasses with an empty one.

In yet another embodiment of the invention, the trap utilizes a suffocating gas instead of a liquid. Any suitable heavier than air gas can be used. One suitable type of gas is CO₂. In this embodiment, a sensor probe is included in the wall of the lower housing 3, or container, and the probe is able to determine the level of the gas within the lower housing 3 or container. A separate supply of gas is provided, and a gas replenishment supply control means is used to supply enough gas into the lower housing or the container to maintain the gas level at an acceptable height. When the rodent falls into the lower housing or the container, it is suffocated by the gas.

In another form of the invention, a physical flag is located on the upper part of the trap and activated by the lever action of the flat panel 11 as an animal falls down into the liquid or gas. This flag indicates to a user that the trap has tripped, and that at least one animal carcass is stored in the lower housing 3, of the container.

So in summary, the present invention is in the form of an enclosed plastic non-toxic baited area that has a teetering trap door arrangement secured and triggered by a magnetic catch or locking device. The mouse travels up an access ramp then enters the baited area through a small hole in the far end of the device then immediately steps onto the end of the locked teetering platform applying a downward force onto the magnetic catch and housing securing the platform. This ensures no sensation of movement is felt by the mouse. The mouse then feels safe and travels along the platform until reaches the pivot point that has low friction properties (such as a bearing) to aid the swift operation of the impending trapdoor effect. Past this point the pressure applied to the magnetic catch end of the device changes to an upward force that will eventually release the catch when the leverage force becomes great enough. The force increases as the mass of the mouse moves along the platform towards the bait station until it releases in a sudden movement. The mouse at this position on the platform when the magnetic catch releases ensures the force of its own weight drops the platform quickly and violently from underneath with no chance of escape. The platform is designed so that various sizes and weight of pests release the catch at different lengths across the platform as the leverage applied to the catch is enough to initiate the release. The mouse then falls into a capturing cavity area below the platform that is filled with a suitable liquid etc. where it is captured. At the point in which the mouse slides off the platform, the weight is shifted slightly biased towards the platforms original position so it returns to be locked by the magnetic catch again. The trap is now automatically set again for the next mouse.

The carcass of the pest is preserved in the liquid containing natural or added antibacterial preserving properties until it is removed by the operator of the device.

While the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not. and should not be taken as. an acknowledgment or any form of suggestion that such prior art forms part of the common general knowledge.

What is claimed is:

1. A trap for assisting in controlling rodent populations comprising:
a lower housing,
a false floor disposed over a portion of the lower housing, said false floor including a trapdoor having a first end and a second end which is pivotable about a low friction bearing positioned closer to said first end than said second end, and
a ramp,
wherein the lower housing has a lower end that sits on the ground and an upper end, and wherein the false floor is attached to the upper end of the lower housing, and the trapdoor is triggered to suddenly collapse when the rodent places a sufficient amount of its body weight onto the trapdoor, and the ramp leads up from ground level to the false floor, a suitable liquid or gas is contained within the lower housing, and a suitable bait is placed on the false floor along the first end to attract a rodent and maneuver it onto the trapdoor, and the rodent is able to easily climb up to the false floor by way of the ramp, and when the rodent moves towards the bait, and places sufficient weight upon the first end of the trapdoor, the trapdoor pivots, thereby causing the first end to drop toward the lower housing such that the rodent falls into the lower housing, wherein the rodent drowns in the liquid, or suffocates in the gas.

2. The trap as defined in claim 1, wherein the false floor is releasably attached to the lower housing.

3. The trap as defined in claim 1, wherein the lower housing is sufficiently dimensioned so that it contains enough liquid or gas to completely immerse the rodent, and thereby drown or suffocate it, and store the carcass of multiple rodents within the liquid or gas.

4. The trap as defined in claim 3, wherein the liquid has a specific gravity less than 1.0 in order to reduce any buoyancy effect from the liquid onto the body of the rodent, and the liquid is also sufficiently viscous to ensure the rodent must exert increased effort to hold its head above the level of the liquid, and these liquid properties combine to ensure the rodent quickly tires and can no longer hold its head above the level of the liquid and drowns, and when unconscious, it ensures that the rodent falls to the bottom of the liquid.

5. The trap as claimed in claim 1, wherein a reservoir of gas, a gas sensor probe, and gas replenishment supply control means are provided, wherein the sensor probe is located at a suitable position on the lower housing to sense the level of the gas within the lower housing, and the probe is able to send data back to the gas replenishment supply control means so that a set level of gas within the lower housing is maintained so that any rodent falling into the lower housing is immersed in, and suffocated by, the gas.

6. The trap as claimed in claim 3, wherein the gas is CO2.

7. The trap as claimed in claim 4, wherein the liquid is completely covered with a layer of small floating items and these help to cause the rodent to become disorientated when it is submerged and swimming in the liquid.

8. The trap as defined in claim 7, wherein the liquid is an oil, such as cooking oil.

9. The trap as defined in claim 1, wherein an upper housing is attached over the lower housing, thereby providing an enclosed and concealed space above the false floor, and the upper housing includes an opening of sufficient size to permit a rodent to pass through into the concealed and enclosed space.

10. The trap as defined in claim 9, wherein a container is removably placed within the lower housing, and the liquid used to drown, or the gas used to suffocate, each rodent is contained wholly within the container.

11. The trap as defined in claim 10, wherein either the lower housing, or the container, includes a mesh basket that sits within the lower housing or the container, so that when the trap needs to be emptied of rodent carcasses, the user can simply lift the basket out of the lower housing or the container, thereby allowing the liquid or gas, and any small floating items to drain out of the basket through the mesh and back into either the lower housing, or the container, leaving the carcasses in the basket ready for disposal.

12. The trap as defined in claim 11, wherein the trapdoor is retained in a substantially horizontal position via quick release retention means, and adjustment means are included so that the amount of weight that the trapdoor can bear before the retention means suddenly release is adjustable.

13. The trap as defined in claim 12, wherein the trapdoor is a flat panel that sits flush with the false floor, and is arranged to pivot about a pivot line, so as to define a first portion of the flat panel that the rodent is supported by, that rotates about the pivot line in a downward direction when the trapdoor is released, and a second portion on the opposite side of the pivot line that moves correspondingly in an upward direction.

14. The trap as defined in claim 13, wherein the flat panel is arranged so that the first portion extends out substantially further from the pivot line than the second portion.

15. The trap as defined in claim 14, wherein the flat panel is biased so that it resets itself once the rodent has fallen through and into the liquid or gas.

16. The trap as defined in claim 15, wherein the retention means is located on the second portion of the flat panel.

17. The trap as defined in claim 16, wherein the retention means is a magnet, and the adjustment means permit the user to position of the magnet at a location on the second portion that is either closer to, or further away from the pivot line.

18. The trap as defined in claim 17, wherein the flat panel occupies a majority of the area of the false floor.
